(19) United States
(12) Patent Application Publication
(10) Pub. No.: US 2003/0182208 A1
(43) Pub. Date: Sep. 25, 2003

(54) Method and system for assisting consumer decision making and providing on-demand viewing access to broadcast and rich media ads

(75) Inventors: Jean-Charles Dupuis, Outremont (CA); Jean-Francois Pouliot, Montreal (CA)

Correspondence Address: OGILVY RENAULT, 1981 MCGILL COLLEGE AVENUE, SUITE 1600, MONTREAL, QC, H3A2Y3, CA

(73) Assignee: ELODA INC., Montreal (CA)

(21) Appl. No.: 10/100,135

(22) Filed: Mar. 19, 2002

(51) Int. Cl. G06F 17/60

(52) U.S. Cl. 705/27; 705/26

(57) ABSTRACT

A system provides on-line members of the public with on-demand viewing of broadcast advertisements at no cost to the consumer. The system permits the consumer to select an ad to be viewed. The web page that plays the ad also displays a link for contacting a vendor of the advertised product. The advertiser is charged each time one of their advertisements is played.

### CROSS-REFERENCE TO RELATED APPLICATIONS

This is the first application filed for the present invention.

### MICROFICHE APPENDIX

Not applicable.

### TECHNICAL FIELD

The invention relates to the field of Internet and broadcast advertising and, in particular, to a method and system for providing on-demand viewing access to broadcast and rich media advertisements at a worldwide web site.

### BACKGROUND OF THE INVENTION

It is well known that public commercial advertising plays an important role in supporting free markets. Many broadcast advertisements, like those aired on television and radio, are considered irritating distractions by audiences uninterested in the content or the products promoted. Nonetheless, recent studies by TiVo® have shown that certain advertisements are at least as desirable to television viewers as programming content. In addition, public Internet and worldwide web sites, such as AdCritic (now defunct), have demonstrated that given an opportunity to view advertising content on demand, many consumers are eager to participate.

It is known in the art to provide on-line shopping marts, such as those provided by yahoo®, Microsoft®, and many others. However, these shopping marts do not leverage the wealth of broadcast advertising material aired over television and radio stations, and generally make no use of rich media advertising techniques. To date, there is no known on-line shopping venue that utilizes the wealth of broadcast advertising material aired over television and radio stations.

Rich media advertisements for promoting products are available on some manufacturer and vendor web sites, but those web sites do not provide access to unbiased information to enable comparison shopping. There is currently no known on-line facility available to members of the public who wish to view or hear a particular ad free of charge. There are companies that, for a price to the consumer, sell and track television commercial advertisements and gather competitive intelligence for advertising industry professionals. However, as noted above, the only company to make broadcast commercial advertisements available to consumers at no cost (AdCritic) has ceased operation, apparently due to a failure to find a viable revenue stream to support their operations. At any rate, AdCritic only published ads for entertainment value, and therefore offered a limited selection of advertisements. To date, there is no known on-line facility that permits consumers to access a broad selection of broadcast advertisements free of charge.

Given the significant expense of creating and broadcasting advertisements, and given the continuously growing number of people who have access to the Internet, it is desirable to re-use television commercial advertising to promote products and services on the Internet.

Consequently, there exists a need for a method and system for assisting consumer decision making and providing on-demand viewing of broadcast and rich media advertising to facilitate informed, comparative shopping.

### SUMMARY OF THE INVENTION

It is therefore an object of the invention to assist consumer decision making by making available to on-line consumers on-demand viewing of content of broadcast and rich media advertisements.

Another object of the invention is to provide a worldwide web site for providing on-demand viewing access to broadcast advertisements, and for displaying, in association with respective advertisements, links or contact information that can be used for contacting vendors of advertised products.

A further object of the invention is to provide a system for disseminating broadcast advertisements, at no cost to consumers who receive the advertisements, while providing a revenue stream for operators of the system.

Accordingly, a system is provided for enabling an on-line consumer to view broadcast and rich media advertisements on demand. The consumer may select an advertisement for viewing by entering search terms, or selecting search items from a menu, for example. Once the consumer has selected an advertisement to view, a display page plays the selection. If available, the consumer may further choose one from a number of versions of the selected advertisement. The versions may include: short and long versions of the ad; different versions produced for different countries; different versions produced in different languages or versions of sub-titles; etc. It will be appreciated that the cost of displaying the advertisement at the ad server is much less than the cost of broadcasting an ad. Consequently, extended length versions (which may be produced during the process of creating the ads) can be economically disseminated, and those extended length versions may do more to promote a product or the interests of the vendor.

The consumer's web browser preferably downloads the selected advertisement in a display page that also provides other options associated with one or more products promoted by the advertisement. The other options preferably permit the consumer to access additional information embedded in access web pages associated with the product(s), a manufacturer of the product(s), and/or a vendor of the product (s). The consumer may also request information that permits the consumer to purchase the product. The information is provided, for example, as a vendor contact web page, which may display information that the consumer can use to access the vendor on-line and/or off-line. The access web pages are preferably all supported by the web site provided by the ad server, in order to maintain uniformity of presentation format, and permit operators of the ad site to ensure accurate content of displayed pages. Access web pages may contain, for example, consumer ratings of the product; an expert opinion page; a product information page with product specifications, or additional information supplied by the vendor or a manufacturer of the product; product reviews; and, hypertext links to on-line vendor sites. If the consumer is not interested in viewing the access web pages, the consumer may view related advertisement. The related advertisement may be, for example, an advertisement for a competitor's product, or a related product offered by the same manufacturer.

The method for assisting consumer decision making therefore involves publishing the web site for providing on-demand viewing of the advertisements, and displaying, in association with viewed advertisements, links to information that the consumer can use to access a vendor of a product promoted in the advertisement. Known technology can be used for constructing display pages to present selected advertisements to the consumer when a content of the advertisements are stored in an ad database (a database of the broadcast and rich media advertisements). The ad server is in communication with the consumer's web browser application via the Internet. The ad server is adapted to respond to such events as a selection by the consumer of an advertisement, a registration of a consumer preference, or a selection of a category of advertisements of interest. The ad server is further adapted to retrieve and package content stored in the ad database, and format the information in hypertext mark-up language (HTML) web pages. An active server page processor, or other server-side processor (SSP) may be required to perform intermediary functions between the database and the web server, to execute the scripts, and to generate the web pages.

A billing method for generating revenue for the service provider that operates the ad server is also provided. In accordance with one billing method, a fixed charge is incurred by the advertiser each time a member of the public plays an advertisement associated with the advertiser. In accordance with another billing method, a percentage of sales of products sold in response to the viewing of the broadcast or rich media advertising is paid to the service provider. Any combination of these two billing methods, as well as any number of miscellaneous fees for opening an account, changing or modifying advertisements, etc., may provide or supplement a revenue stream for the service provider.

### BRIEF DESCRIPTION OF THE DRAWINGS

Further features and advantages of the present invention will become apparent from the following detailed description, taken in combination with the appended drawings, in which:

FIG. 1 is a schematic diagram of principal elements of an Internet environment in which the present invention is deployed;

FIG. 2 is a message flow diagram illustrating a first example of principal steps performed by elements of the invention shown in FIG. 1;

FIG. 3 is a message flow diagram illustrating another example of principal steps performed by elements of the invention shown in FIG. 1;

FIG. 4 is a schematic illustration of information folders used by an ad server in accordance with an embodiment of the present invention to assist consumer decision making;

FIG. 5 is a schematic illustration of an exemplary ad selection page in accordance with an embodiment of the invention;

FIG. 6 is a schematic illustration of an exemplary display page in accordance with an embodiment of the invention, constructed in response to an ad selection made from an ad browsing menu; and

FIG. 7 is a schematic illustration of an exemplary display page constructed in response to an ad selection made from an ad search menu.

It should be noted that, throughout the appended drawings, like features are identified by like reference numerals.

### DETAILED DESCRIPTION OF THE PREFERRED EMBODIMENT

The present invention provides a method and system for on-demand viewing of television commercials and other broadcast or rich media advertisements at no cost to the consumer. Rich media is an Internet advertising term for enhanced ads that include animation, audio, video, and/or interaction with the consumer. As used in this document, broadcast advertisement means any prerecorded commercial used for advertising, whether aired on television or not, including rich media advertisements. The method and system provides advertisers with exposure to an audience that is interested in viewing advertisements for their products, while ensuring a revenue stream for service providers that make the broadcast advertisements available on demand to consumers. In accordance with an embodiment of the invention, the method and system also enable a unique shopping venue that assists consumer decision making by providing consumers with on-demand access to broadcast advertising and other product-related information, including direct links to vendors or vendors contact information.

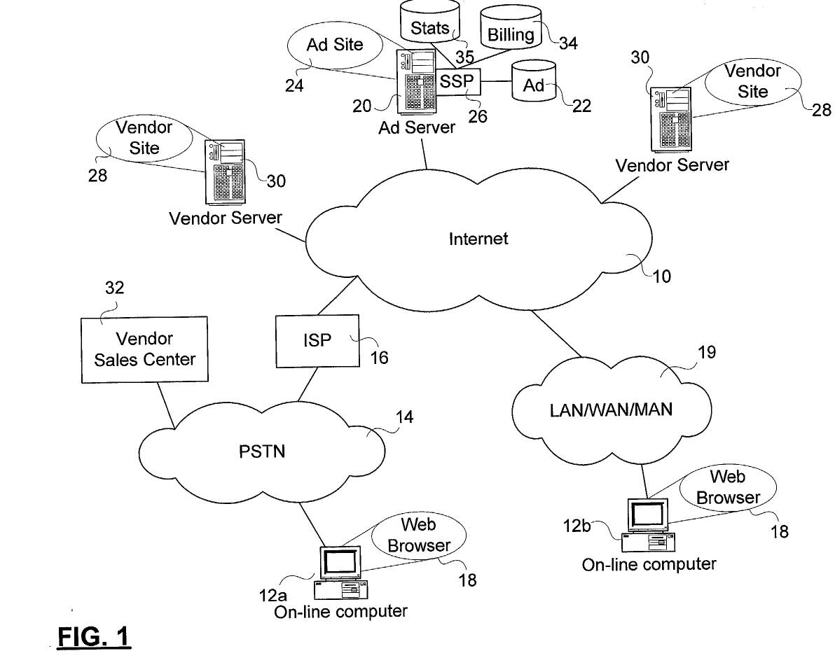

FIG. 1 schematically illustrates principal elements of an Internet environment in which the invention is deployed. An Internet 10 is a network for interconnecting on-line computers 12a,b (generally referred to herein as computers 12) and servers 20,30 using Internet Protocol (IP) messages carried over a transport control protocol (TCP). The interconnection permits the computers 12 to request and download web pages written in hypertext transfer protocol (HTTP) that are stored on the servers, and identified by respective uniform resource locators (URLs), as is known in the art. Some consumers access the Internet 10 via telephone subscriber lines in a public switched telephone network (PSTN) 14. A consumer using the computer 12a accesses content from the Internet 10 via an Internet Service Provider (ISP) 16. As is known in the art, the connection between the on-line computer 12a and the ISP 16 may be a digital subscriber line (DSL), a dial-up connection, or an Integrated Services Digital Network (ISDN) connection, or the like. The on-line computer may be stationary, or mobile, and in wireless, or wireline connection with the ISP 16. Other conduits to the Internet 10 are known in the art, including access through a local/wide/metropolitan area network (LAN/WAN/MAN) 19. As shown in FIG. 1, the on-line computer 12b accesses Internet content via the LAN/WAN/MAN 19.

In accordance with the invention, a server (ad server 20) provides on-line consumers with an opportunity to view broadcast and rich media advertisements stored on an ad database 22. Preferably, the ad database 22 includes a wide selection of television commercial advertisements, aired to a television viewing area, so that consumers can expect to find favorite television commercial advertisements at the ad server. Advertisements aired in different television viewing areas, or different countries, and those recorded in different languages, along with different versions, and those with sub-titles in different languages, may also be stored on the ad database 22. The different versions of broadcast advertisements may include extended length versions of advertisements, which may have been created during the process of filming an aired advertisement.

The ad server 20 is preferably configured to take advantage of the Internet to provide more to the consumer than simply displaying the content of television commercial advertisements. There are a number of tools that can be used to advantageously promote advertised products. The Internet medium permits the display of much more information at lower cost. The Internet also enables consumer interaction. So, for example, a consumer can request supplementary or competitive information, consumer reports or the like to facilitate a purchase decision. Effective leveraging of the Internet 10 as an advertising medium can enhance the advertisement viewing experience for the consumer, and attract more customers to the vendor.

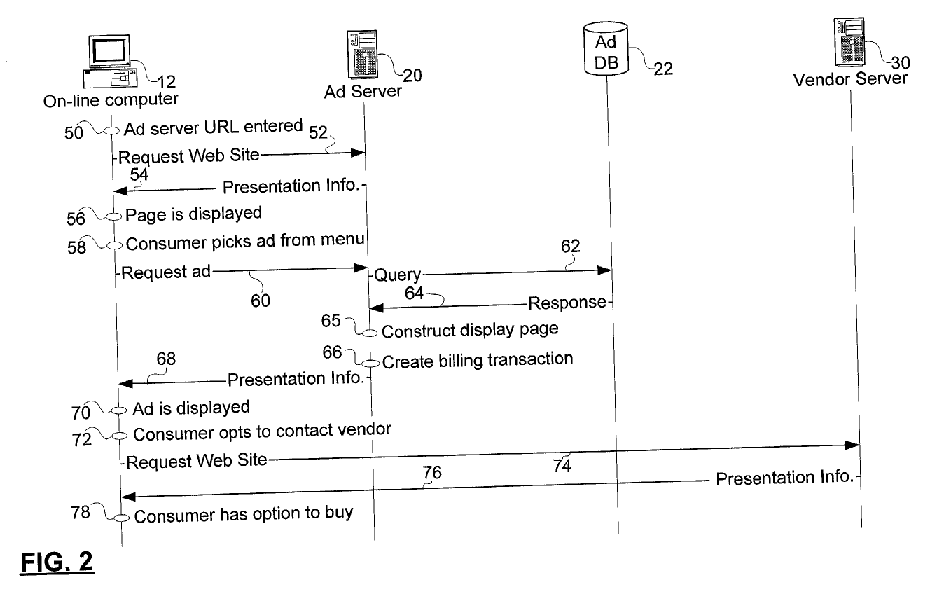

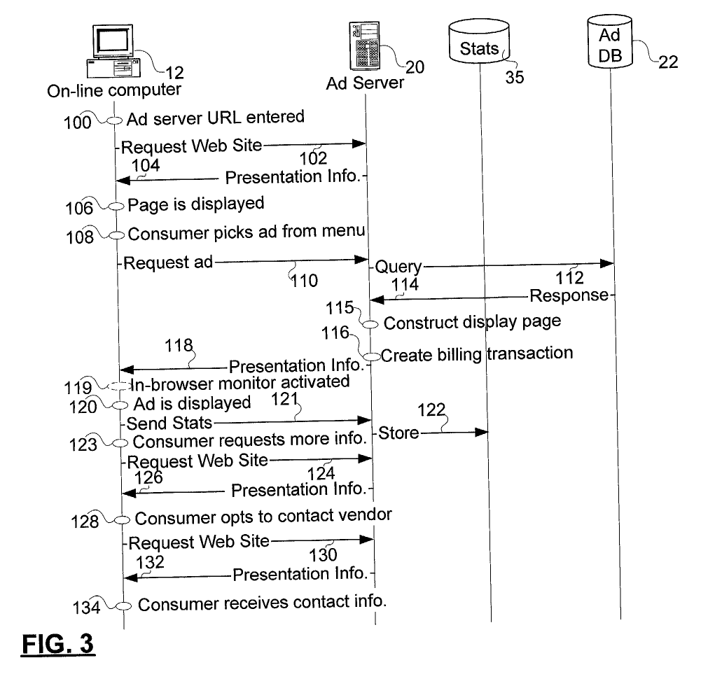

The operation of the ad database 22 and the ad server 20 is funded by the advertisers of products promoted by the broadcast and rich media advertisements. Consequently, the ad server 20 also has access to a billing database 34, the function of which will be explained below in more detail with reference to FIGS. 2 and 3. These advertisers may wish to provide additional information related to the product, its uses, the manufacturer, etc. Moreover, the ad server 20 may be promoted as a consumer decision making aid, and provide access to resources for assisting the consumer in appraising an advertised product. Such resources may include, for example, one or more pages for consumer evaluation of the products; a product, product line, or category of product forum; an expert opinion page; a product information page with product specifications, or other information provided by the vendor or a manufacturer of the product; and, hypertext links to other on-line resources related to the product.

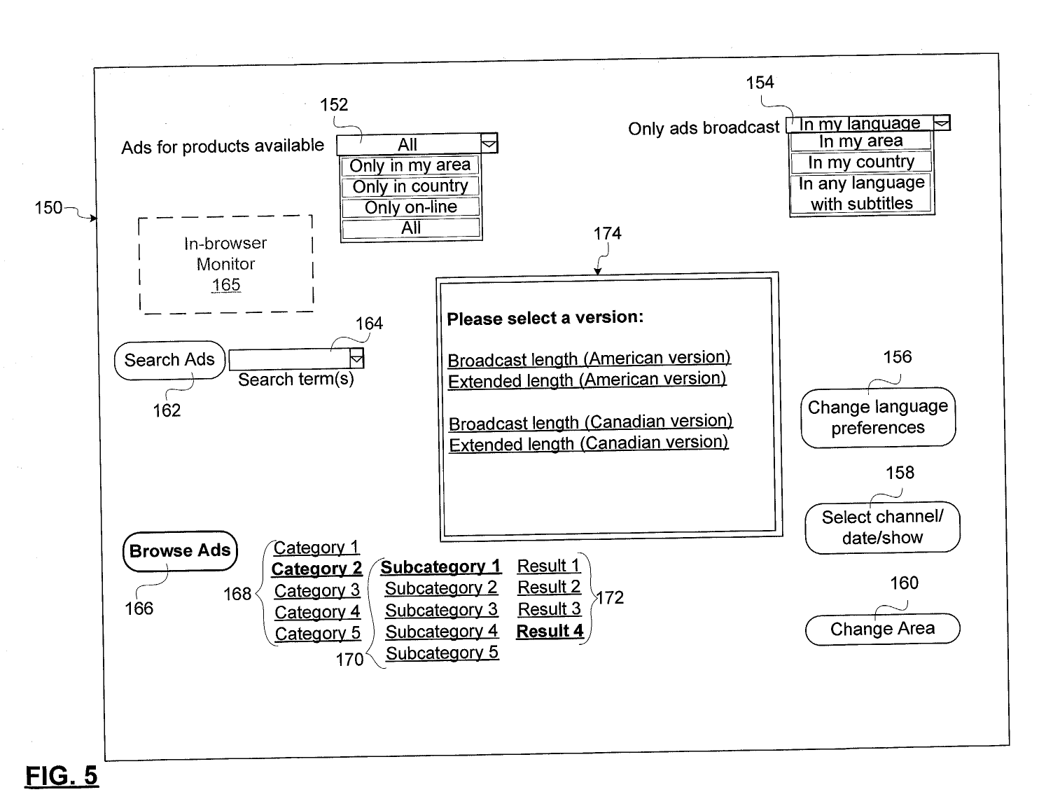

In order to effectively leverage the Internet medium, the other information related to a product promoted in a selected advertisement is made available to the consumer in association with the selected advertisement. In order to minimize download time, and to maintain a uniform viewing of web pages, it is generally preferable to provide access to the other information using hypertext links to other web pages on the ad server 20. As is well understood by those skilled in the art, a web site is a collection of at least one web page of data organized around a theme or topic. The ad site 24 is adapted to permit viewing of many different broadcast and rich media advertisements and, accordingly, is capable of providing many web pages. Uniformity of view of these web pages is important for enabling the consumer to readily identify pages provided by the ad site 24. It is also technically feasible to maintain uniform views by using templates for the web pages. Examples of two kinds of web pages of the web site, and further discussion of their presentation, is provided below with reference to FIGS. 5, 6 and 7.

One convenient way of providing template-driven web pages for the ad site 24, while facilitating access to the ad database 22, is to use a server-side processor (SSP) 26, adapted to receive messages from the web browser 18 of a consumer, and process script files embedded in the web pages. Methods of server-side processing of web content are known in the art. Languages like Perl and various versions of Active Server Page (ASP) are known to facilitate dynamic page construction, particularly in relation to pages constructed in response to database queries. Several other tools for authoring web pages are also publicly available, such as Adobe's GoLive software. The SSP 26 is basically responsible for receiving the messages, retrieving information from the ad database 22, and packaging the retrieved information into HTTP web pages that are transmitted to the consumer's web browser 18 by the ad server 20, in reply to the messages.

When an advertisement is selected by the consumer from among the broadcast and rich media advertisements that are stored on the ad database 22, if the selected advertisement promotes a product offered by a vendor who subscribes to the advertisement dissemination services provided by the ad server 20, and if the vendor has a web site (such as vendor site 28) for supporting on-line purchases of the product, product support, or just a home page, then the display page (the web page that plays the selected advertisement for the consumer) further includes a hypertext link to the vendor's site 28. There are, naturally, many different methods of contacting a vendor, and the vendor decides whether instructions or a hypertext link are presented by the display page. FIG. 1 illustrates two vendor servers 30 that support respective vendor sites 28, and one vendor sales center 30 that provides telephone commerce support.

FIG. 2 illustrates principal messages exchanged by elements illustrated in FIG. 1 during a visit by a consumer to the ad server site 24. In step 50, the consumer, using the web browser application 18 running on an on-line computer 12, selects the URL of the ad site 24, and consequently an IP message is generated to request the ad site 24 (step 52). In a manner known in the art, the request is forwarded through the Internet 10 to the ad server 20. The ad server 20 returns the home page of the ad site 24 with all its embedded presentation information, to the on-line computer 12 (step 54), which then displays the home page of the ad site 24 (step 56). In step 58, the consumer selects an advertisement from a menu of the broadcast and rich media advertisements stored in the ad database 22. As will be appreciated by those of skill in the art, advertisement selection may require an exchange of messages between the on-line computer 12 and the ad server 20 (not illustrated) depending on how the advertisement is selected. In other embodiments, there may be any number of steps involved in selecting an advertisement for viewing.

Once the advertisement is selected, the web browser 18 formulates a request for a display page of the selected advertisement. The request is forwarded, in step 60, to the ad server 20, which advances the request to the server-side processor (SSP) 26. The SSP 26 queries ad database 22 (step 62) for the information associated with the selected advertisement. The information associated with the advertisement is included in a response message, in reply to the query (step 64). The ad server 20, in step 65, assembles the information received in the response to construct the display page. A billing transaction for the display of the selected advertisement is created, in step 66. The billing transaction is, for example, stored by the SSP 26 in the billing database 34 (FIG. 1) and subscriber invoices (not shown) are periodically produced by a billing process in a manner well known in the art. The display page is then sent to the on-line computer 12 (step 68), and the web browser 18 plays the advertisement for the consumer (step 70), which may be in streaming media format, for example.

For the sake of illustration, it is assumed that the consumer watches the advertisement, and chooses to contact the vendor, in order to purchase a product promoted by the advertisement. In this case, a button on the display page, featuring a purchase icon or phrase such as “click here to buy”, is selected by the consumer (step 72), and the web browser formulates and sends another message to fetch presentation information from a vendor site 28 associated with the product (step 74). In step 76, the presentation information fetched from the vendor site 28 is received at the on-line computer 12, and the consumer can order the product.

It should be understood that in the following context, “product” menus any good or service. Further, “purchasing” or “ordering” the product includes any subscription, exchange, promise, offer, contract or other such action in support of an exchange or transfer of the product.

FIG. 3 illustrates principal messages exchanged by elements illustrated in FIG. 1 during a consumer's visit to the ad site 24, in which the consumer obtains information regarding a product promoted in a selected advertisement, but does not pursue an on-line purchase transaction. Steps 100-120 are substantially identical to steps 50-70 of FIG. 2, and are not described, with the exception that a new step 119 is added to illustrate an optional feature of the invention. The optional feature permits a service provider that operates the ad server 20 to supply subscribers with viewing statistics, and other statistics related to consumer behavior. The statistics provide subscribers with valuable feedback respecting, for example, which ads are viewed in their entirety, which ads prompt sales, what other information is requested, and with what frequency, etc.

In step 119, an optional in-browser monitor 165 (FIGS. 5-7) is activated. The in-browser monitor collects statistics respecting consumer activity and periodically sends the collected statistics to the ad server 20, where the SSP 26 stores them in the stats database 35 (FIG. 1). The in-browser monitor in one embodiment is parameter-driven, so that it can be tailored to the subscriber whose advertisement is selected by the consumer for viewing. In step 120, the advertisement is displayed as described above with reference to FIG. 2. In step 121, the in-browser monitor sends statistics to the ad server 20 to indicate, for example, how long the requested ad was played by the consumer. In step 122, the SSP 26 of ad server 20 stores the statistics in the stats database 35. Statistical reports are generated from statistics stored in the stats database 35 on an ad-hoc or scheduled basis in a manner well known in the art.

In step 123, the consumer chooses to obtain more product information. The display page includes a number of hypertext links to information for assisting the consumer in evaluating the product. These hypertext links provide the consumer with an opportunity to access information and resources related to the product. The resources may include information provided by the vendor, a manufacturer of the product, independent experts familiar with the product, or other consumers, for example. The consumer, in step 122, selects one of the hypertext links, and subsequently a web page is requested (step 124) from the ad server 20. The ad server 20 returns the presentation information (step 126), and the selected web page is presented to the consumer. The information may be, for example, provided on a web page that has substantially the same layout as the display page, with additional information supplied in a viewing area that, in the previous display page, played the advertisement. In step 128, the consumer requests instructions for contacting the vendor by selecting another hypertext link. IP messages are sent to the ad server 20 (step 130) and returned (step 132), and the instructions, a toll-free telephone number for example, are displayed for the consumer (step 134).

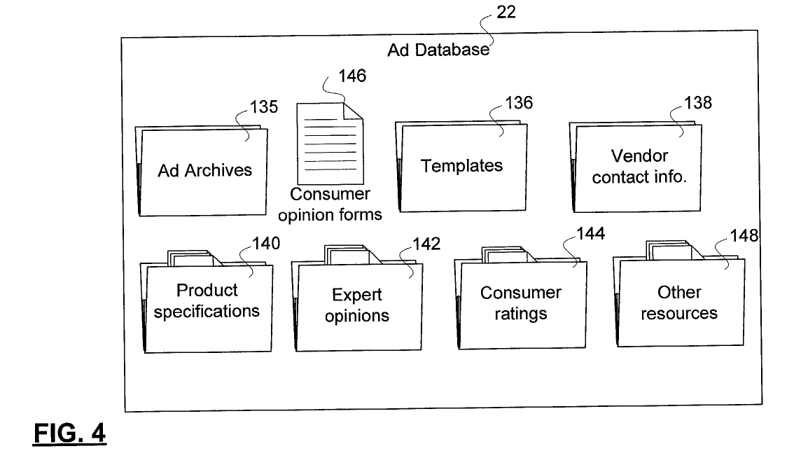

FIG. 4 schematically illustrates folders that the ad server 20 accesses to provide information to consumers who access the ad site 24. The server-side processor 26 of the ad server 20 may use templates for constructing web pages in response to information requests received from consumers. In order to enable the display web page to present the consumer with options for accessing supplemental information related to the product, a number of hypertext links to different resources must be inserted into the display page before it is sent to the consumer. Those hypertext links may be default uniform resource locators (URLs), but the SSP 26 preferably dynamically inserts respective URLs during construction of the display web pages, so that, each time a selection of an advertisement is made, the display page is customized to provide links to other web pages for displaying content related to the product promoted in the selected advertisement. In the illustrated embodiment, besides the advertisement archives 135 there are folders for links to vendor contact information 138, product specifications 140, expert opinions 142, consumer ratings 144 and other resources 146, such as competitive products, comparison products, related ads, or the like.

The folder for product specifications 140 provides product information and specifications provided by the advertiser. The product information may relate to any number of subjects, depending on numerous factors. For example, the product specifications may include installation information, product design specifications, standards information, information regarding how and where the product may be deployed, cost, methods of delivery or payment, component options, safety precautions, assembly instructions, etc.

The folder for expert opinion 142 provides the consumer with an opportunity to read at least one expert opinion related to the product promoted in the selected advertisement. The information may be provided in the form of a list of frequently asked questions with answers provided by independent experts, for example. Expert testimonials or critical evaluations may also be provided.

The folder for consumer ratings 144 provides ratings or opinions left by other consumers who have used the product. The opinions may be provided by consumers who have previously purchased products and were requested to complete a consumer opinion form 146, or who enter text directly on a voluntary basis.

The folder for other resources 148 may include a plurality of links to web pages that contain company news, technical advice related to the product, promotions, contests, or any other material believed to promote sales of the product.

FIG. 5 schematically illustrates an exemplary ad selection page 150 displayed by the ad server 20 to permit a consumer to select an advertisement for viewing. The ad selection page 150 provides the consumer with options for searching advertisements and options for selecting an advertisement to be viewed.

The options for searching advertisements may permit the consumer to eliminate advertisements from the search based on a language preference, broadcast information relating to the advertisement, availability of a product promoted in an advertisement, or the like. In accordance with one embodiment, a pull-down menu 152 is provided for screening the set of available advertisements based on product availability. The consumer may choose to restrict the advertisements for viewing to those promoting products available in their region or country, for example. The consumer may also elect to restrict the selection of advertisements for viewing to those that promote products sold on-line. A pull-down menu 154 permits the consumer to screen the advertisements for viewing by region, language of dissemination, or those with sub-titles in a preferred language. As will be understood by those skilled in the art, other search aids or screening criteria may also be provided to facilitate a search of available ads.

The consumer is permitted to select or change language preferences used to screen the advertisements for viewing using a language preferences button 156. The consumer can also select a station, date or program broadcast during which an advertisement was aired, in order to help expedite the search for an advertisement, using button 158. A change area button 160 permits the consumer to enter another geographical area, which may be used as explained above for screening the advertisements searched.

In one embodiment, two mechanisms for selecting advertisements to view are provided to the consumer, although any number of other mechanisms for selecting can be provided in equally operable embodiments. A first mechanism for selecting uses a search interface 162. The selection page 150 provides the consumer with a search term field 164 in which search terms are entered for retrieving a list of advertisements the consumer may wish to view. There may be more than one type of search supported. For example, advanced searches may be provided to permit searches based on product type, actor or actress, or theme, etc.

A second mechanism for selection provides a browsing interface 166 that permits a selection of categories 168 (five shown). One of the categories 168 (category 2) is highlighted indicating that it has been selected, and five sub-categories 170 are displayed, the five sub-categories being related to category 2. A sub-category 1 of the five sub-categories 170 is highlighted, indicating that it has been selected, and a menu 172 of four results (ads) associated with the selected sub-category 1 are displayed. A result 4 of the menu 172 is highlighted, indicating that the result 4 has been selected for viewing by the consumer.

In the example illustrated in FIG. 5, the selection of the result 4 does not uniquely identify an advertisement and, consequently, a selection window 174 is displayed to the consumer, overlaying the selection page 150. The selection window 174 prompts the consumer to select a version of the advertisement which, in this example, is available in versions broadcast in two different countries, as well as in respective extended length versions.

The browsing and/or searching activity of the consumer may be monitored by an in-browser monitor 165, which is completely transparent to the consumer. The in-browser monitor 165 collects statistics about consumer activities and sends collected statistics to the ad server 20, where the SSP 26 stores the statistics in the stats database 35, as described above with reference to FIG. 3. As also described above, the in-browser monitor 165 in one embodiment is parameter-drive and may optionally only be active when the ads of certain subscribers are requested.

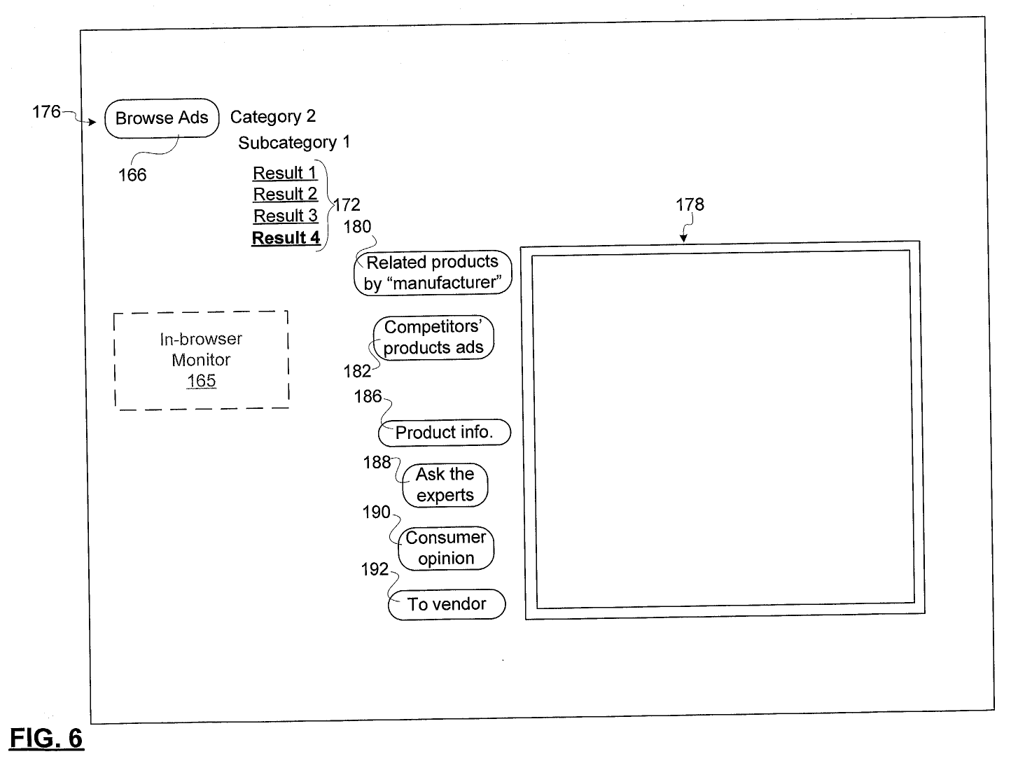

Upon selection of the version to be played, the consumer is presented with a display page 176, such as that schematically illustrated in FIG. 6. The display page 176 may display a summary of the selection made and other buttons, icons or lists for selecting related advertisements to view. The display page 176 contains a viewing area 178 for playing the selected advertisement, and a plurality of buttons or icons for providing the consumer with information related to the product promoted by the advertisement played.

In this example, the summary of the selection made by the consumer using the ad selection page displays the browsing interface 166, the selected category (category 2), sub-category (sub-category 1) and the menu 172 of results of the search, with the selected result (result 4) highlighted. The consumer can therefore continue browsing after the advertisement is played. Two other buttons or lists provide access to related advertisements that may be selected for viewing. A related products button 180 provides the consumer with access to advertisements for related products offered by the manufacturer. The other button 182 provides the consumer with access to advertisements promoting products that compete with the product promoted by the selected advertisement, for example.

The display page 176 preferably also provides the consumer with access to information available in the folders illustrated in FIG. 4. Consequently, there are hypertext links to product information (186) stored in the product specifications folder 140, expert opinion (188) stored in the expert opinion folder 142, a consumer ratings (190) stored in the consumer ratings folder 144, and a vendor contact option (192) permitting the consumer to link directly to a vendor web site or to contact information stored in the vendor contact information folder 138.

The selected advertisement is displayed in viewing area 178. The content of the advertisement may be displayed using a streaming video format, and preferably does not require the consumer to download a special player. As described above with reference to FIG. 2, the in-browser monitor 165 may actively collect statistics about the viewing habits of the consumer.

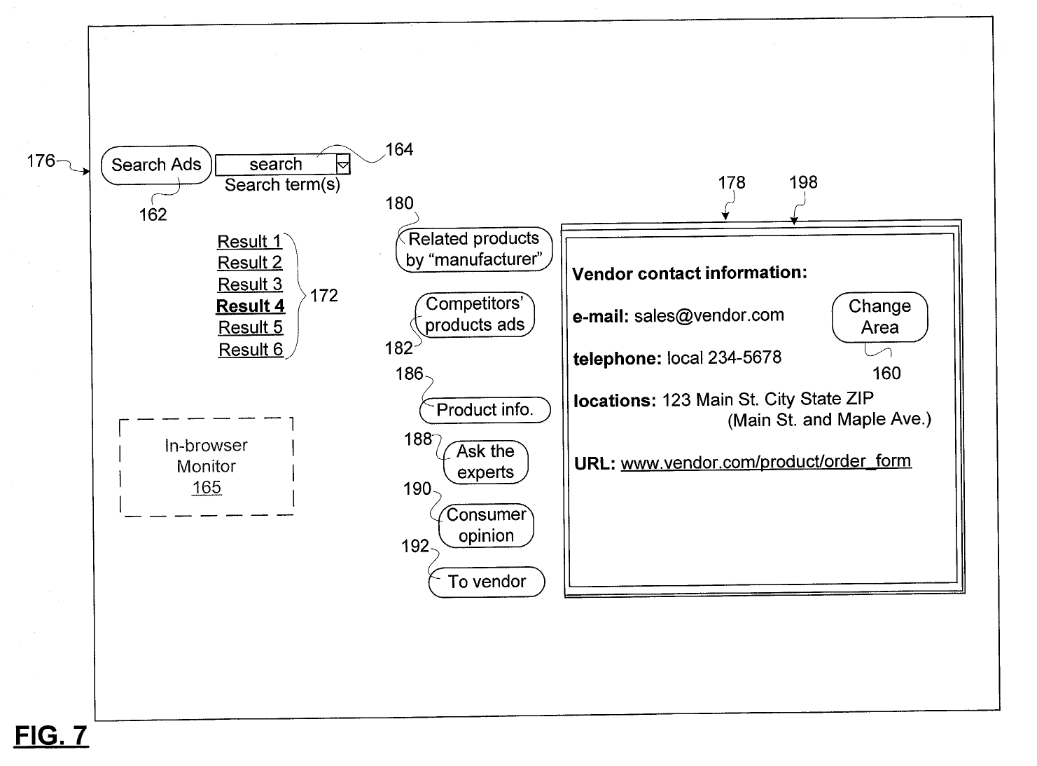

FIG. 7 schematically illustrates a second example of a display page 176. The display page shown in FIG. 7 differs from that shown in FIG. 6 in that the advertisement selection performed prior to display of the page shown in FIG. 6 was different than the advertisement selection performed prior to the display of page 176, shown in FIG. 7. Whereas the browsing interface 166 was used to select the advertisement displayed by page 176 shown in FIG. 6, the consumer used the search interface 162 to select the advertisement displayed by page 176 shown in FIG. 7. Consequently, the search interface 162, and the search term field 164 containing the input search term (“search”) are displayed. Another menu 172 of results of the search is displayed, this time with six results. The result four was selected to be played, and is therefore highlighted. The related products button 180 and the competitor's products button 182 are also displayed. The display area 178 is the same as that illustrated in FIG. 6. The hypertext links to respective resources (184-192) are identical with those of FIG. 6, except that the hypertext link 192 to the vendor contact web page is highlighted, indicating that it has been selected. This selection prompted the ad server 20 (FIG. 1) to download a page of vendor contact information extracted from the vendor contact information folder 138 (FIG. 4).

In this example, the vendor contact information includes an offer to purchase the product immediately from an on-line vendor, as well as contact information for a local distributor. Other alternatives for contacting the vendor may also be provided. If there are several local vendors of the product, the contact information for different vendors may be displayed or, as previously discussed, the vendor could be selected on a basis of proximity to the location indicated by the consumer. The telephone number and contact address are selected in relation to a location previously entered by the consumer. The vendor contact web page may therefore provide the consumer with an opportunity to change their location using the change area button 160.

As will be appreciated, the schematic illustrations of the selection and display pages are only exemplary of many possible presentations for providing the consumer with an opportunity to view, on demand, broadcast or rich media advertisements.

The system and methods in accordance with the invention therefore provide on-line consumers with on-demand access to broadcast and rich media advertisements at no cost, while providing vendors with fee-based dissemination of the content of the broadcast and rich media advertisements. The system and methods in accordance with the invention also provide a unique shopping venue where consumers are both entertained and assisted in making informed purchase decisions.

The embodiments of the invention described above are intended to be exemplary only. The scope of the invention is therefore intended to be limited solely by the scope of the appended claims.

We claim:

1. A method for providing an on-line consumer with on-demand on-line viewing access to broadcast advertisements, the method comprising steps of:
providing the consumer with an on-line interface for selecting an advertisement to be played for viewing, the interface being displayed at an on-line computer operated by the consumer;
sending an advertisement selected by the consumer to a web browser application running on the on-line computer, which plays the advertisement for viewing by the consumer; and
creating a billing transaction to charge an advertiser for retrieving and sending the selected advertisement to the on-line computer operated by the consumer.

2. A method as claimed in claim 1 further comprising a step of providing the consumer with an on-line interface for permitting the consumer to select one of broadcast advertisements, rich media advertisements and rich media versions of a broadcast advertisements.

3. A method as claimed in claim 1 wherein the step of providing the consumer with an on-line interface for selecting an advertisement comprises providing an interface that permits the consumer to select a language in which the advertisement was broadcast.

4. A method as claimed in claim 1 wherein the step of providing the consumer with an on-line interface for selecting an advertisement comprises providing an interface that permits the consumer to select a language in which sub-titles for the advertisement are displayed.

5. A method as claimed in claim 1 wherein the step of providing the consumer with an on-line interface for selecting an advertisement comprises providing an interface that permits the consumer to select a region in which the advertisement was broadcast.

6. A method as claimed in claim 1 wherein the step of providing the consumer with an on-line interface for selecting an advertisement comprises providing an interface that permits the consumer to select a category of products to which the advertisements are related.

7. A method as claimed in claim 1 wherein the step of sending comprises steps of:
querying a database to retrieve the selected advertisement; and
constructing a display page to play the selected advertisement for viewing by the consumer.

8. A method as claimed in claim 7 wherein the step of constructing further comprises steps of:
retrieving references to information related to the selected advertisement; and
inserting the references to the information into predefined areas of the web page.

9. A method as claimed in claim 8 wherein the step of retrieving comprises a step of retrieving a list of advertisements that advertise products that compete with a product promoted by the selected advertisement.

10. A method as claimed in claim 8 wherein the step of retrieving comprises a step of retrieving at least one reference to expert opinion related to a product promoted by the selected advertisement.

11. A method as claimed in claim 8 wherein the step of retrieving comprises a step of retrieving at least one reference to a consumer rating of a product promoted by the selected advertisement.

12. A method as claimed in claim 8 wherein the step of retrieving comprises a step of retrieving a reference to at least one of product specifications, product information and promotional literature related to a product promoted by the selected advertisement.

13. A method as claimed in claim further comprising a step of monitoring consumer activity to collect statistics related to any one of browsing, searching, viewing and requesting additional information about broadcast advertisements or advertised products.

14. A method as claimed in claim 8 further comprising steps of:
receiving a message from the web browser application requesting information related to the selected advertisement;
constructing a display page to display the requested information for the consumer; and
sending the web page to the web browser application to display the requested information for the consumer.

15. A method as claimed in claim 14 wherein the step of receiving comprises a step of receiving a request for vendor contact information.

16. A method as claimed in claim 15 wherein the step of constructing comprises a step of inserting into the display page one of a link to an on-line vendor site, and contact information to permit the consumer to contact the vendor off-line.

17. A worldwide web site for providing an on-line consumer with a facility for selecting and viewing broadcast advertisements on demand, comprising:
a web server for sending web pages to an on-line computer operated by the consumer, the web pages being adapted to permit the consumer to select one advertisement from a plurality of advertisements and view the advertisement using a web browser application running on the on-line computer; and
a user-selectable option presented to the consumer in association with a web page for playing the selected advertisement, the option permitting the consumer to request information that enables the consumer to contact a vendor of a product promoted by the advertisement.

18. A worldwide web site as claimed in claim 17 wherein at least one of the web pages include an in-browser monitor for monitoring at least one of the consumer's activities associated with the web pages.

19. A worldwide web site as claimed in claim 17 wherein the information that enables the consumer to contact the vendor comprises a link to a worldwide web server that permits the consumer to purchase the product on line.

20. A worldwide web site as claimed in claim 17 further comprising a user-selectable option presented to the consumer in association with a web page for playing the selected advertisement, the option permitting the consumer to request information that enables the consumer to read expert opinion related to the product promoted by the advertisement.

21. A worldwide web site as claimed in claim 17 further comprising a user-selectable option presented to the consumer in association with a web page for playing the selected advertisement, the option permitting the consumer to request information that enables the consumer to inspect consumer ratings of the product promoted by the advertisement.

22. A worldwide web site as claimed in claim 17 further comprising a user-selectable option presented to the consumer in association with a web page for playing the selected advertisement, the option permitting the consumer to request information that enables the consumer to inspect information related to the product promoted by the advertisement.

23. A worldwide web site as claimed in claim 17 further comprising a user-selectable option presented to the consumer in association with a web page for playing the selected advertisement, the option permitting the consumer to select advertisements for products that are related the product promoted by the advertisement.

24. A worldwide web site as claimed in claim 17 further comprising a user-selectable option presented to the consumer in association with a web page for playing the selected advertisement, the option permitting the consumer to select advertisements related to products that compete with the product promoted by the advertisement.

25. A worldwide web site as claimed in claim 17 further comprising one or more web pages structured to permit a consumer to search a collection of advertisements related to a particular category of products.

26. A worldwide web site as claimed in claim 25 wherein the one of the web pages comprises consumer selectable options for limiting a search to advertisements recorded in a specific language.

27. A worldwide web site as claimed in claim 25 wherein the one of the web pages comprises consumer selectable options for limiting a search to a collection of advertisements recorded with sub-titles in a specific language.

28. A worldwide web site as claimed in claim 25 wherein the one of the web pages comprises consumer selectable options for limiting a search to a collection of advertisements broadcast in a specific geographical region.

29. A system for disseminating broadcast advertisements at no cost to a consumer, the system comprising a server adapted to serve a web page to the consumer for playing a broadcast advertisement selected by the consumer, the web page further providing the consumer with one of a link for contacting an on-line vendor of a product promoted by the selected broadcast advertisement and a link to information to permit the consumer to contact a vendor of the product off-line.

30. A system as claimed in claim 29 further comprising means for generating a billing transaction for charging an advertiser associated with the advertisement each time a consumer is served an advertisement to be played.

31. A system as claimed in claim 29 further comprising an in-browser monitor for collecting statistics related to at least one activity of the consumer served the web page.

32. A system as claimed in claim 30 wherein the server is further adapted to serve a web page comprising links to other information related to a product promoted by the advertisement to be played.

33. An on-line shopping web site, comprising:
a worldwide web server adapted to accept a request from a consumer to play a broadcast advertisement on demand, and further adapted to serve a web page to a web browser application run by an on-line computer operated by the consumer, in order to play the advertisement for the consumer and provide the consumer with one of a link to an on-line vendor of a product promoted by the advertisement played and information to permit the consumer to contact the vendor; and
a database of broadcast advertisements from which the worldwide web server retrieves the advertisement to be played.

34. An on-line shopping web site as claimed in claim 33 further comprising means for creating a billing transaction each time a consumer requests that a one of the broadcast advertisements be played.

35. An on-line shopping web site as claimed in claim 33 wherein the worldwide web server is further adapted to customize the page served to the consumer so that the page includes consumer selectable options for retrieving information related to a product promoted by the advertisement played.

36. An on-line shopping web site as claimed in claim 33 wherein the web page served to the consumer includes an in-browser monitor adapted to monitor at least one activity of the consumer served the web page in order to collect statistics that are sent to the worldwide web server.
